(19) United States
(12) Patent Application Publication
(10) Pub. No.: US 2014/0359196 A1
(43) Pub. Date: Dec. 4, 2014

(54) ON-THE-FLY PERFORMANCE ADJUSTMENT FOR SOLID STATE STORAGE DEVICES

(71) Applicants: Daniel J. Ragland, Hillsboro, OR (US); Christopher E. Saleski, Portland, OR (US); Richard P. Mangold, Forest Grove, OR (US); Chun L. Yi, Richmond (CA); Pranava Y. Alekal, Hillsboro, OR (US); Kevin Southern, Aloha, OR (US)

(72) Inventors: Daniel J. Ragland, Hillsboro, OR (US); Christopher E. Saleski, Portland, OR (US); Richard P. Mangold, Forest Grove, OR (US); Chun L. Yi, Richmond (CA); Pranava Y. Alekal, Hillsboro, OR (US); Kevin Southern, Aloha, OR (US)

(21) Appl. No.: 13/929,708

(22) Filed: Jun. 27, 2013

Related U.S. Application Data
(60) Provisional application No. 61/829,983, filed on May 31, 2013.

(51) Int. Cl. G06F 12/00

(52) U.S. Cl. CPC G06F 12/00
USPC 711/102

(57) ABSTRACT

Methods and apparatus related to on-the-fly performance adjustment techniques for solid state storage devices are described. In one embodiment, a controller logic controls access to one or more non-volatile memory devices. The controller logic causes a change in an operational frequency of one or more of: the controller logic, a bus that couples the one or more non-volatile memory devices to the controller logic, and one or more of the one or more non-volatile memory devices. Also, the controller logic is capable of causing the change in the operational frequency in response to a command. Furthermore, changing power limits is made possible to scale solid state storage device performance based on system capabilities. Other embodiments are also disclosed and claimed.

### RELATED APPLICATION

This application relates to and claims priority from U.S. Provisional Patent Application No. 61/829,983, entitled “ON-THE-FLY PERFORMANCE ADJUSTMENT FOR SOLID STATE STORAGE DEVICES,” filed on May 31, 2013.

### FIELD

The present disclosure generally relates to the field of electronics. More particularly, some embodiments of the invention generally relate to on-the-fly performance adjustment techniques for solid state storage devices.

### BACKGROUND

Generally, memory used to store data in a computing system can be volatile (to store volatile information) or non-volatile (to store persistent information). Volatile data structures stored in volatile memory are used for temporary or intermediate information that is required to support the functionality of a program during the run-time of the program. On the other hand, persistent data structures stored in non-volatile memory are available beyond the run-time of a program and can be reused. Moreover, new data is typically generated as volatile data first, before the user or programmer decides to make the data persistent. For example, programmers or users may cause mapping (i.e., instantiating) of volatile structures in volatile main memory that is directly accessible by a processor. Persistent data structures, on the other hand, are instantiated on non-volatile storage devices like rotating disks attached to Input/Output (I/O or IO) buses or non-volatile memory based devices like flash memory.

To increase performance, some systems may utilize a Solid State Drive (SSD) that includes non-volatile memory such as flash memory to provide a non-volatile storage solution. Such SSDs generally take less space, weigh less, and are faster than more traditional hard disk drives (HDDs). Furthermore, hard disk drives provide a relatively low-cost storage solution and are used in many computing devices to provide non-volatile storage. Hard disk drives, however, can use a lot of power when compared to Solid State Drives since a hard disk drive needs to spin its rotating disks at a relatively high speed and move disk heads relative to the spinning disks to read/write data. All this physical movement generates heat and increases power consumption.

To this end, some mobile devices are migrating towards solid state drives. Also, some stationary computing systems (such as desktops, workstations, servers, etc.) may utilize such solid state drives to improve performance. However, utilizing the same usage model for solid state drives in different types of computing devices may not always result in an optimal balance between performance and reliability.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1, 5, and 6-7 illustrate block diagrams of embodiments of computing systems, which may be utilized to implement various embodiments discussed herein.

FIGS. 2, 4, and 4A illustrate flow diagrams according to some embodiments.

FIG. 3 illustrates a sample user interface to provide control over tuning of a solid state storage device, according to an embodiment.

FIG. 4B illustrates a block diagram of various components of an SSD, according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

Some embodiments provide for on-the-fly performance adjustment techniques for solid state drives. As discussed herein, “on-the-fly” or “dynamic” performance adjustment generally refers performance adjustment without requiring a computing system reboot or Operating System (OS) reboot. Also, such solid state drives may include flash memory (also referred to herein interchangeably as a solid state storage device), Phase Change Memory (PCM), Spin Torque Transfer Random Access Memory (STTRAM), Resistive Random Access Memory, 3D (3-Dimensional) Cross Point Memory, etc. Hence, some embodiments provide methods and/or apparatus to enable dynamic performance control of SSDs. An embodiment enables end-users to dynamically control the performance of SSDs, trading off between performance, reliability, thermal constraints, and/or device lifetime. In one embodiment, a command interface (e.g., via software) allows for making such performance trade-offs on-the-fly, e.g., from within an OS.

In an embodiment, an end-user may utilize techniques/features discussed herein to adjust/tune the performance of a SSD, for example, by enabling SSD over-clocking. Over-clocking generally refers to increasing the operating frequency of a component (such as an SSD) beyond a normal/default operating frequency, e.g., to increase performance. For example, the tuning may be based on OEM (Original Equipment Manufacturer) and/or end-user tolerance to changes in thermal, power, and/or reliability conditions. Such approaches allow for utilizing different characteristics or usage model for SSDs in different types of computing devices to provide a more optimal balance between one or more of performance, reliability, power consumption, thermal conditions, etc.

Moreover, without some embodiments, SSDs used in larger desktop systems with additional power delivery and cooling capability may have to operate within the same constraints of SSDs used in ultra-thin notebooks and their lesser cooling and power delivery capabilities. Also, a file server may have different reliability expectations than a gaming system. To this end, some embodiments allow for a system designer (or savvy user) to have input into these platform tradeoffs. Furthermore, some embodiments provide for a platform-based SSD “Turbo” like capability, e.g., where SSD's performance can be adjusted (also referred to herein as “tuning”), in real-time or during runtime, for one or more (consecutive or non-consecutive) time periods and/or based on various criterion such as: software workload demands, sensor data, and/or environmental conditions. Additionally, Intel® Corporation's Extreme Tuning Utility (XTU) enables end-users to over-clock the Central Processing Unit (CPU), Graphics Processing Unit (GPU), and/or system memory to achieve higher system performance. This utility may be extended in an embodiment to allow for end-users to over-clock their SSDs, e.g., resulting in improved performance for storage I/O (Input/Output) bound workloads. Further, while allowing the ability to over-clock SSDs, some embodiments avoid the potential for extensive data loss (e.g., when a solid state storage device controller stops operating). Moreover, while some embodiments herein discuss techniques applied to SSDs, it is envisioned that the same or similar techniques may also be applied to other types of non-volatile memory devices.

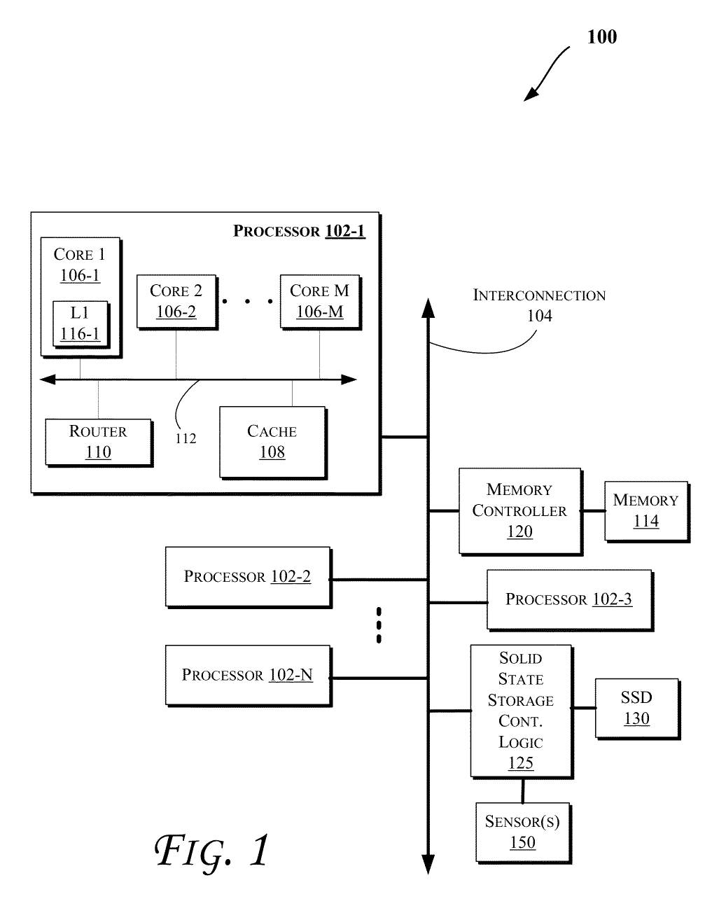

The techniques discussed herein may be provided in various computing systems (e.g., including smart phones, tablets, portable game consoles, Ultra-Mobile Personal Computers (UMPCs), etc.), such as those discussed with reference to FIGS. 1-7. More particularly, FIG. 1 illustrates a block diagram of a computing system 100, according to an embodiment of the invention. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

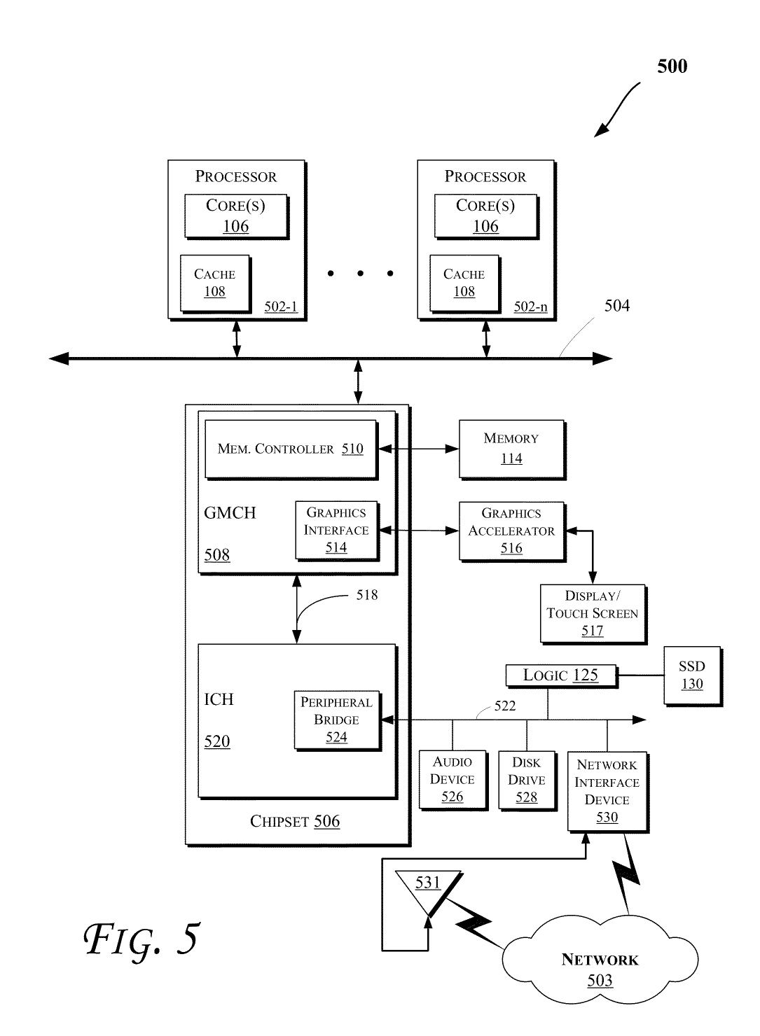

In an embodiment, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 120, memory controllers (such as those discussed with reference to FIGS. 5-7), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that are utilized by one or more components of the processor 102-1, such as the cores 106. For example, the cache 108 may locally cache data stored in a memory 114 for faster access by the components of the processor 102. As shown in FIG. 1, the memory 114 may be in communication with the processors 102 via the interconnection 104. In an embodiment, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

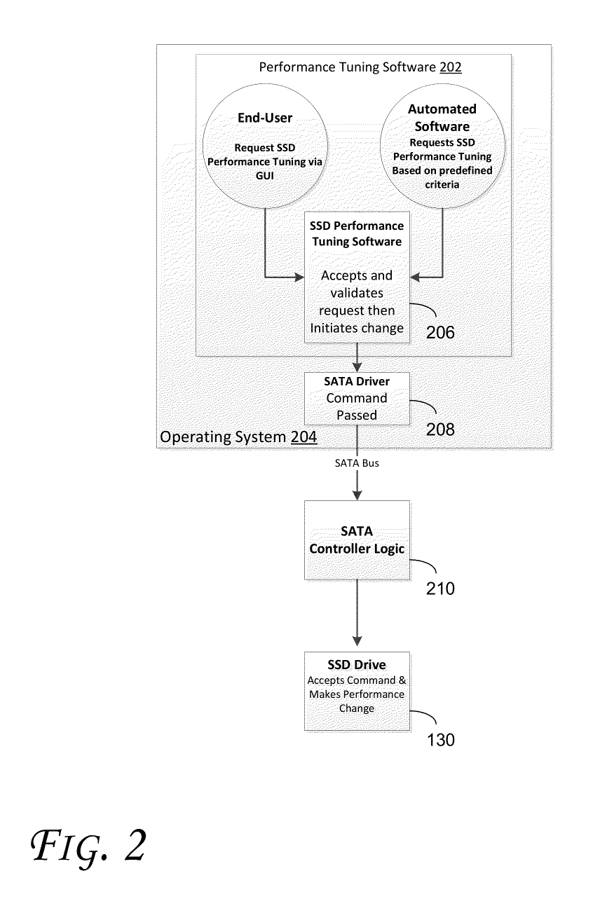

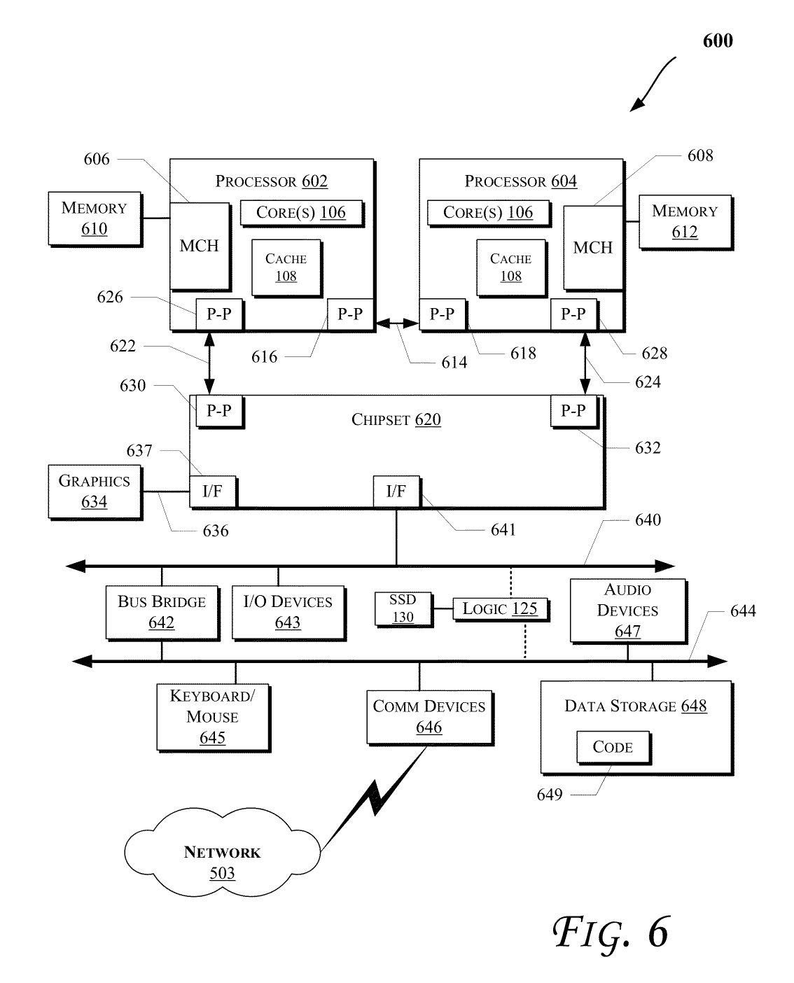

As shown in FIG. 1, memory 114 may be coupled to other components of system 100 through a memory controller 120. Memory 114 may include non-volatile memory such as flash memory (or a solid state storage device, including an SSD), PCM, STTRAM, Resistive Random Access Memory, 3D Cross Point Memory, etc. in some embodiments. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments. Also, in some embodiments, system 100 may include logic (e.g., solid state storage controller logic 125) to control access to one or more NVM or Non-Volatile Memory (including one or more solid state storage) devices (such as one or more SSDs 130, further discussed with reference to FIG. 2), where the one or more NVM devices may be provided on the same integrated circuit die in some embodiments). Furthermore, even though logic 125 is shown to be directly coupled to the interconnection 104 in FIG. 1, logic 125 can alternatively communicate via a storage bus/interconnect (such as the SATA (Serial Advanced Technology Attachment) bus discussed with reference to FIG. 2) with one or more other components of system 100 (for example where the storage bus is coupled to interconnect 104 via some other logic like a bus bridge, chipset (such as discussed with reference to FIGS. 5-6), etc.). Additionally, logic 125 may be incorporated into a memory controller (such as those discussed with reference to FIGS. 1 and 5-6) or at least provided on a same integrated circuit device in various embodiments.

Furthermore, logic 125 may be coupled to one or more sensors 150 to receive information (e.g., in the form of one or more bits or signals) to indicate the status of or values detected by the one or more sensors 150. The sensor(s) 150 may be provided proximate to components of system 100 (or other computing systems discussed herein such as those discussed with reference to other figures including 5-7, for example), such as the cores 106, interconnections 104 or 112, components outside of the processor 102, SSD, SSD bus, SATA bus, logic 125, etc., to sense variations in various factors affecting power/thermal behavior of the system/platform, such as temperature, operating frequency, operating voltage, power consumption, and/or inter-core communication activity, etc.

FIG. 2 illustrates a high level flow diagram for tuning an SSD, according to an embodiment. While FIG. 2 discusses tuning of an SSD, the same or similar techniques may also be applied to any type of solid state storage NVM device. As illustrated, performance tuning software 202 (which may be an application running within an OS 204) includes an SSD performance tuning software application 206 that accepts and validates SSD performance tuning request(s) from an end-user (e.g., via a Graphical User Interface (GUI)) and/or from an automated software application (e.g., based on one or more predefined criteria).

At an operation 208, a driver command is passed to initiate the turning/change to the SSD performance (e.g., via a storage device driver such as a Serial Advanced Technology Attachment (SATA) driver). The driver command is passed to a SATA controller logic 210 (e.g., include in a Peripheral Control Hub (PCH) or other hardware) via a SATA bus. In an embodiment, the SATA controller 210 is the same or similar to the logic 125 of FIG. 1. In turn, SSD 130 accepts the command and makes the performance change that apply to the SSD (such as changing the operating frequency of the bus that couples an internal SSD controller to the non-volatile memory cells in the SSD, the non-volatile memory cells, and/or other components of the SSD).

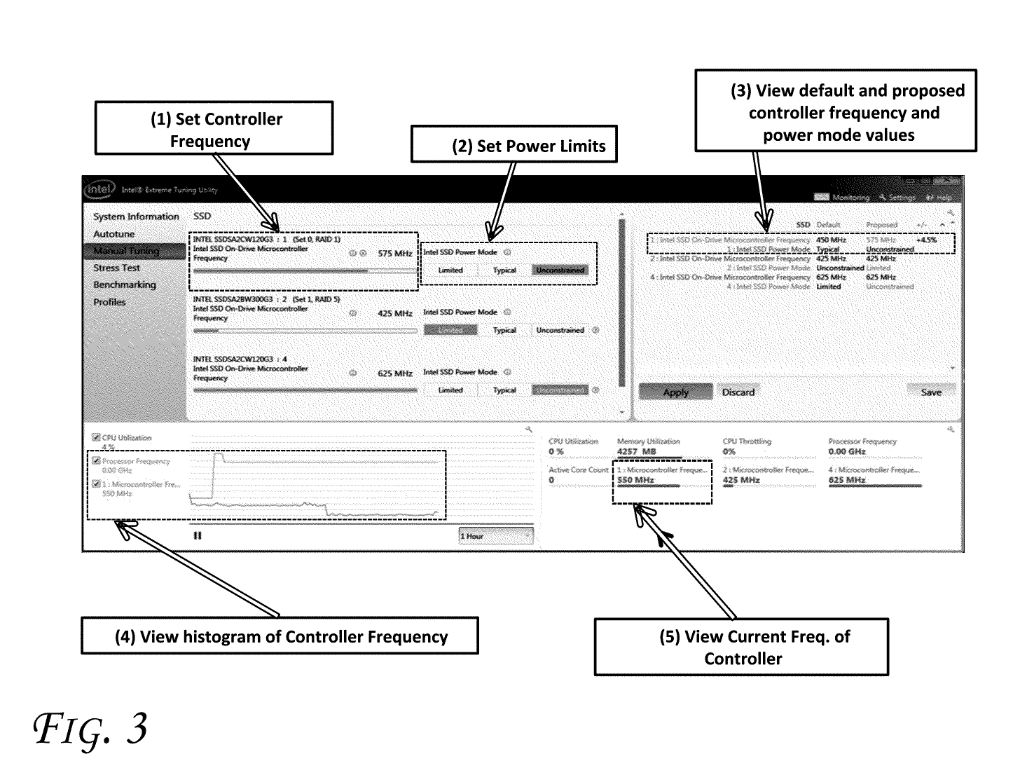

FIG. 3 illustrates a sample GUI to provide software controls to tune an SSD, according to an embodiment. As discussed herein, turning an SSD refers to adjusting the performance of a SSD, for example, by enabling SSD over-clocking. Also, over-clocking generally refers to increasing the operating frequency of a component (such as an SSD, its interface/bus, or the SSD controller logic 125, etc.) beyond a normal/default operating frequency, e.g., to increase performance. For example, the tuning may be based on OEM and/or end-user tolerance to changes in thermal, power, and/or reliability conditions. While FIG. 3 discusses techniques for tuning an SSD, the same or similar techniques may also be applied to other types of solid state storage devices. FIG. 3 illustrates a sample implementation using Intel® Extreme Tuning Utility (XTU) in one embodiment. As shown, the GUI allows for setting of SSD controller frequency (1) such as the operating frequency of the logic 125 of FIG. 1, setting SSD power limits (2), viewing default and proposed SSD controller frequency and power mode values (3), viewing a histogram of the SSD controller frequency over a give time period (4), and/or viewing current SSD controller operating frequency (5).

Moreover, some embodiments provide for on-the-fly adjusting of performance characteristics for solid state storage devices (including SSDs) by providing the ability to make changes without a system or OS reboot. It allows a plurality of real-time tuning options via software and/or hardware communication and control mechanisms to manage dynamic tuning as discussed with reference to FIGS. 2-3, for example. In an embodiment, a command interface is provided for detecting configurable options and communicating changes to a solid state storage drive.

For example, FIG. 3 illustrates how a software application can be used to adjust performance characteristics of the SSD. While a sample implementation is discussed with reference to FIGS. 2-3, embodiments of the invention can be instantiated through different combinations of services, applications, and background services.

Accordingly, some embodiments enable solid state storage device over-clocking by tuning the frequency of the device controller (e.g., logic 125 of FIG. 1), dynamically scaling the controller logic frequency beyond stock level through an SCT (Smart Command Transport) command (which may be transmitted over a SATA bus or another interface, including for example, over the interconnect 104 of FIG. 1), enabling burst power in-rush to storage device safe power limit (e.g., where “in-rush” refers to a peak period of power consumption during burst of data transfer), enabling (e.g., SOC (System On Chip)) power consumption to exceed OEM specified threshold through an API (Application Program Interface), enabling (e.g., NAND and/or NOR, or other types of NVM) flash memory over-clocking by dynamically scaling flash frequency beyond stock level through the SCT command, and/or screening of solid state storage device controllers for highest performance bins by using internal registers (e.g., via segmentation or “bin-ing” of solid state storage device controllers by their determined/assigned upper/maximum operating frequency limit). A “bin” generally refers to a collection of electronic components that are assigned an SKU (Stock Keeping Unit) based on their determined/assigned operating frequency rating.

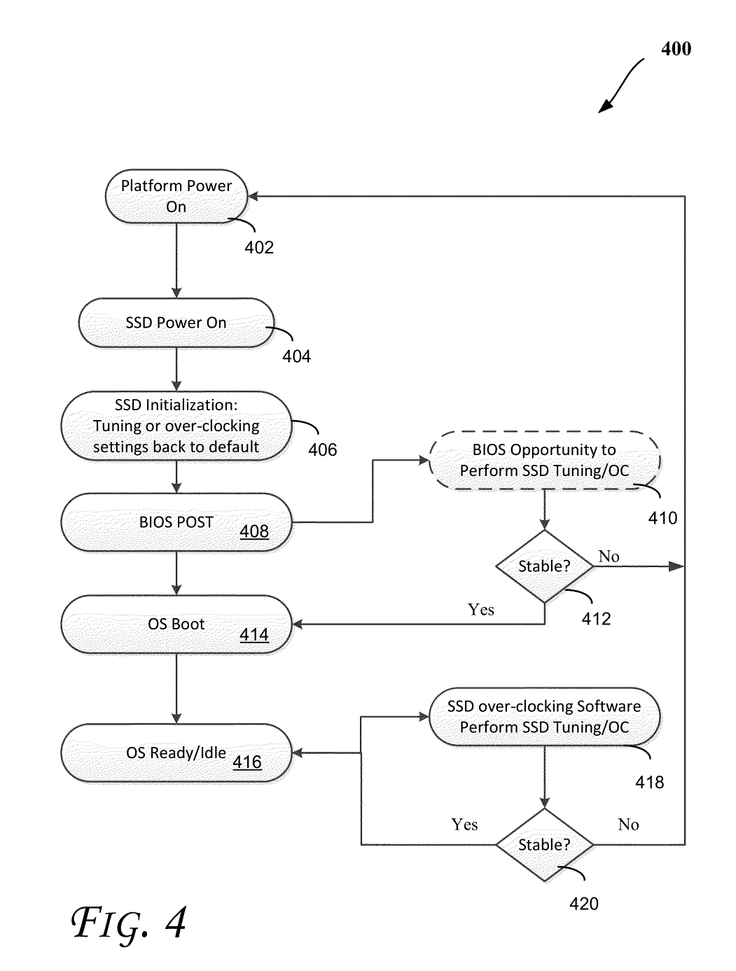

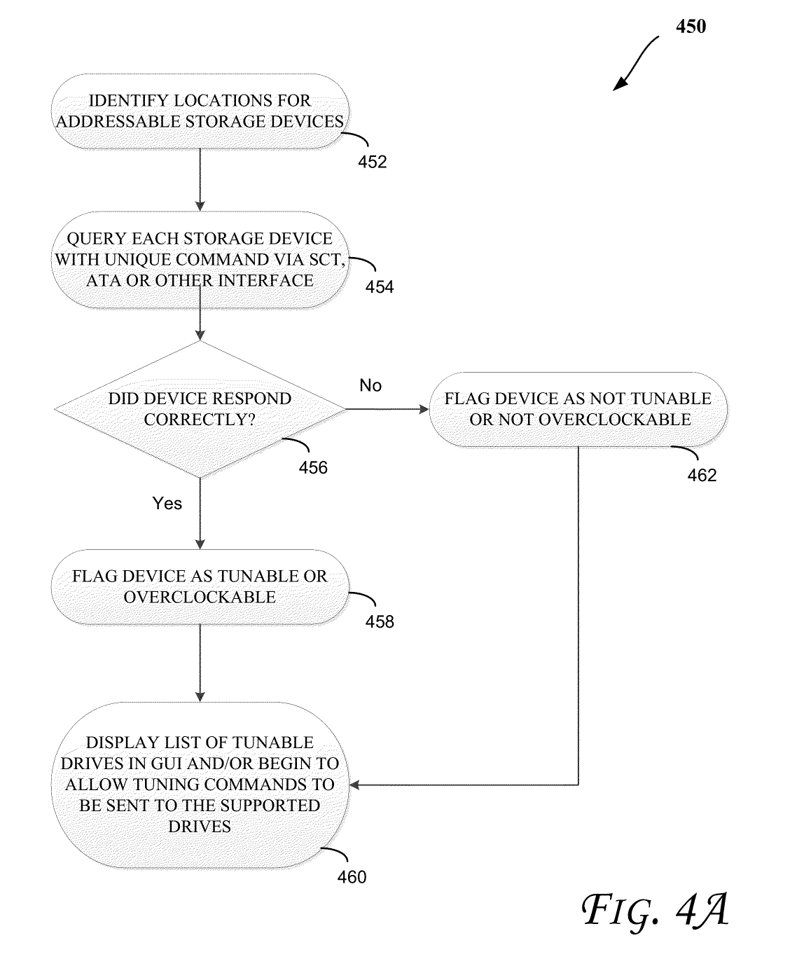

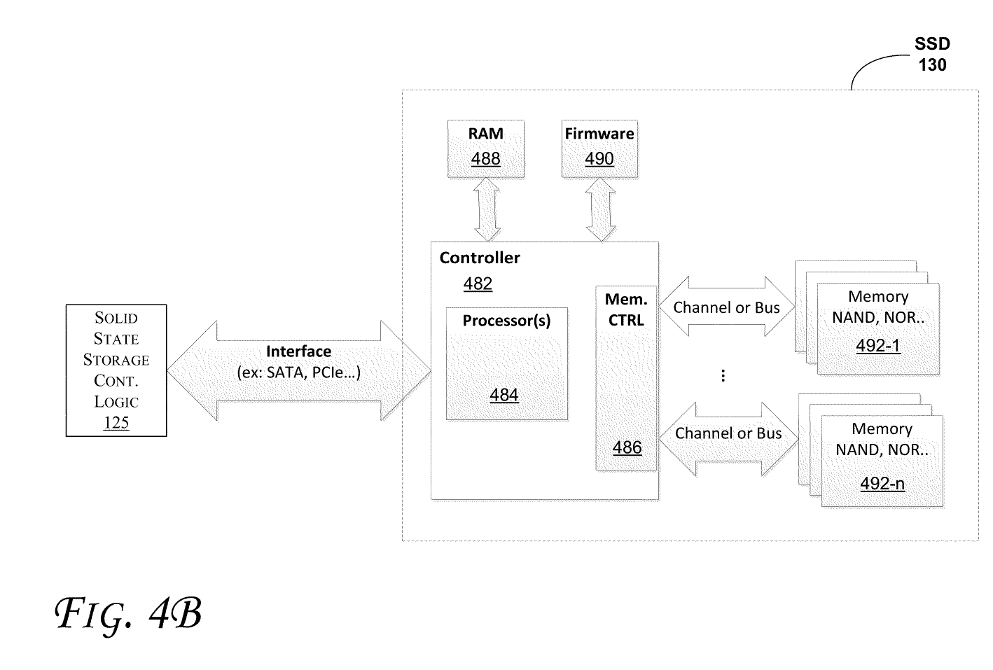

Furthermore, such techniques may be used to enable an “SSD Turbo” feature where platform logic (such as software and/or firmware) can dynamically modify SSD performance to balance/change performance versus battery life in particular form-factors and operating conditions. Also, some embodiments prevent catastrophic failures (e.g., caused by malicious attacks) by providing recovery methods (such as discussed with reference to FIG. 4) and fixed boundaries on input ranges for tuning parameters of SSD performance (such as threshold frequency values for the flash device and/or controller logic 125) to provide further protection, as will be further discussed below. Also, a utility may be provided to reinitialize the drive after failure, e.g., by wiping the drive and making it useable again.

FIG. 4 illustrates a flow diagram of a method 400 to recover from failure according to an embodiment. Method 400 may be used to regain stability after failure, e.g., due to selection of overly aggressive tuning parameters when tuning performance of an SSD. While FIG. 4 discusses tuning techniques for an SSD, the same or similar techniques may also be applied to other types of NVM devices. In various embodiments, one or more operations of method 400 can be performed by one or more components discussed with reference to the other figures (e.g., the logic 125).

Referring to FIG. 4, after platform power on at operation 402, an SSD is powered on at operation 404. At an operation 406, SSD initialization is performed (e.g., by returning the tuning or over-clocking settings to default values). At an operation 408, BIOS (Basic Input Output System) Power On Self Test (POST) is performed. At an operation 410, the BIOS has an opportunity to perform SSD testing and/or OC (Over-Clocking). An operation 412 determines whether the SSD operations are stable and if not, the system resets by returning to operation 402. Otherwise, method 400 continues with OS boot at operation 414 (e.g., from the SSD or another NVM device). Alternatively, operation 408 may be directly followed by operation 414. At an operation 416, OS is ready and operating (e.g., idle). In an embodiment, operations 418 and/or 420 are performed (once the OS is operational at operation 416) to tune SSD over-clocking/tuning and determine stability of the SSD operations at current settings. If SSD operations become unstable at operation 420, the system resets by returning to operation 402.

Various embodiments use SCT and/or ATA (Advanced Technology Attachment) commands to communicate with SSDs to invoke the tuning or over-clocking. The SCT command may be transmitted via a SATA command sent to an SSD. Table 1 below lists SCT commands that may be used in some embodiments (which may be vendor specific in some embodiments). One embodiment uses SCT commands for the NAND timing value, the maximum controller frequency value, and accumulated power value. In an embodiment, an SSD over-clocking lock command is used to prevent users from over-clocking the drive via software unless explicitly unlocked (e.g., helping prevent malicious code or some users from doing harm). Hence, locking prevents tuning or over-clocking and unlocking allows changes. The locking command may cause setting (or clearing depending on implementation) of a lock status bit in some storage device (such as a memory (including memories discussed with reference to FIG. 1 or 5-7), register, memory in the controller logic 125, in firmware, in the SSD, etc.). For additional protection, some embodiments bound/limit the range of the accepted vales for these items below.

TABLE 1

| | SCT | ATA | |
|---|---|---|---|
| | Command | Command | ATA |
| Feature Name | Code | Code | Address |
| Controller Logic Frequency | 0xD005 | 0x3F | 0xE0 |
| Read (or System PLL Timing) | | | |
| Controller Logic Frequency | 0xD006 | 0x3F | 0xE0 |
| Write (or System PLL | | | |
| Timing) | | | |
| Power Mode Read/Write | 0xD001 | 0x3F | 0xE0 |
| NAND Timing Read (e.g., | 0xD006 | 0x3F | 0xE0 |
| Maximum System PLL | | | |
| Timing Value) | | | |
| NAND Timing Write (e.g., | 0xD007 | 0x3F | 0xE0 |
| Accumulated Power Value) | | | |
| Drive Over-clocking Lockout | None | 0x3F | 0xE0 |

Furthermore, ATA commands may be used to read the SSD's model/serial numbers and other identification information (e.g., from the ATA addresses in a storage device, firmware, etc.). The temperature of the SSD may also be monitored via ATA command (e.g., via one or more of the sensors 150 of FIG. 1, which may be physically proximate to the SSD, within the SSD, or otherwise thermally coupled to the SSD).

Some embodiments make use of the existing SCT and ATA command protocols; however, new commands are added for the unique tuning features discussed herein (e.g., such as shown in Table 1). The majority of commands used are SCT based commands. For example, with respect to the last line of Table 1, the Drive Over-clocking Lockout command is created (and a half dozen others shown in Table 1) to manage the ability to tune SSD performance on-the-fly and in real-time (rather than via hard coded firmware that SSD manufacturers would use to develop/test their solutions, for example).

Moreover, some embodiments use ATA commands, e.g., for telemetry as inputs to feedback loops where intelligent software dynamically changes tuning parameters. For example, when pushing the boundaries of performance, the storage device may heat-up and ATA commands to retrieve temperature data can be used to help detect this situation and reduce one or more tuning parameters to keep the drive in healthy operating conditions.

FIG. 4A illustrates a flow diagram of a method 450 to determine which drives or storage devices (e.g., SSDs) in a system are capable of being tuned, according to an embodiment. In an embodiment, method 450 is performed before exposing the option to tune the performance to a user via software or utilities. In various embodiments, one or more operations of method 400 can be performed by one or more components discussed with reference to the other figures (e.g., the logic 125).

Referring to FIG. 4A, at an operation 452, locations for addressable storage devices are determined. At an operation 454, each storage device (identified at operation 452) is queried with a unique command (e.g., via SCT/ATA commands or another interface). At an operation 456, if the device responds correctly to the query of operation 454, that device is flagged as tunable at an operation 458. At an operation 460, a list of tunable drives are displayed (e.g., in a Graphical User Interface (GUI)) and/or tuning commands are allowed to be sent to the supported drives. As shown in FIG. 4A, if the device fails to respond at operation 456, an operation 462 flags the device as not tunable and method 450 return to operation 460.

FIG. 4B illustrates a block diagram of various components of an SSD, according to an embodiment. As shown in FIG. 4B, SSD 130 includes a controller logic 482 (which in turn includes one or more processor cores or processors 484 and a memory controller logic 486), Random Access Memory (RAM) 488, firmware storage 490, and one or more memory modules 492-1 to 492-n (which may include NAND, NOR, or other types of non-volatile memory). Memory modules 492-1 to 492-n are coupled to the memory controller logic 486 via one or more memory channels or busses. Also, SSD 130 communicates with logic 125 via an interface (such as a SATA, PCIe (Peripheral Component Interconnect express), etc. interface).

Moreover, tuning may be initiated by system software (e.g., application, utility, etc.) or system BIOS. Also, tuning may be initiated manually (e.g., via a user GUI) or automatically (e.g., by intelligent logic, including software and/or firmware). Commands to initiate this tuning may utilize the SCT or ATA protocols such as discussed with reference to Table 1 above. For example, when initiated from within the OS, the commands pass through the storage device driver (which may be stored in memory 114 of FIG. 1, for example), the system interface, SATA, or PCIe bus, to the storage device (e.g., SSD 130). Controller logic 482 on the storage device then executes firmware code to parse and execute the commands.

In an embodiment, controller logic 482 can change its own clock/operating frequency by changing the ratio (a.k.a., multiplier) to its existing clock. For example, if the controller's nominal clock is 33.3 MHz and normally fixed ratio is 3 for a 100 MHz effective frequency, changing the ratio to 4 would provide a higher (e.g., 133 MHz) clock frequency which can accelerate performance. Similarly, the clock/operating frequency of one or more of the bus(es) or channel(s) coupled between the memory modules 492-1 to 492-n and memory controller logic 786, as well as operating/clock frequencies of one or more of the memory modules 492-1 to 492-n may be changed in various embodiments. Moreover, while an example of changing ratios is provided, it may also be possible to change the nominal clock frequency directly instead (or in addition thereto). In such cases, the flow would be similar and may optionally include communication/control of an external clock source.

In accordance with some embodiments, the knobs used may include one or more of: (a) controller logic 125 frequency, e.g., derived from system PLL (Phase Locked Loop) timing (e.g., between about 400 MHz to 625 MHz); (b) SSD bus frequency that may include the SATA bus coupled to the SSD, an internal bus in the SSD that is coupled to the non-volatile memory cells of the SSD, etc. (e.g., switching between about 83 MHz and 100 MHz); and/or (c) power mode (such as low, typical, unconstrained, etc.).

Additionally, in accordance with some embodiments, the values being monitored may include one or more of: temperature, controller logic 125 frequency, flash memory bus frequency (e.g., which may be the same as controller logic 125 frequency), solid state storage device operating frequency, and/or accumulated power.

Furthermore, some embodiments provide for a platform-based solid state storage device “Turbo” like capability, e.g., where solid state storage devices performance can be increased, e.g., in real-time, for one or more (consecutive or non-consecutive) time periods and/or based on various criterion such as: software workload demands, sensor data, and/or environmental conditions. The SSD Turbo feature can be built by putting the SSD tuning and over-clocking building blocks discussed herein together. Hence, some embodiments provide a framework, for the first time, which allows dynamic changes to SSD performance, including monitoring frequency(ies), power consumption, and closed-loop parameters. In this fashion, the general principle of Turbo may be applied to SSDs, e.g., speeding up SSDs to meet peak demands and slowing down SSDs (utilizing lower power levels) when the demand is reduced.

FIG. 5 illustrates a block diagram of a computing system 500 in accordance with an embodiment of the invention. The computing system 500 may include one or more central processing unit(s) (CPUs) 502 or processors that communicate via an interconnection network (or bus) 504. The processors 502 may include a general purpose processor, a network processor (that processes data communicated over a computer network 503), an application processor (such as those used in cell phones, smart phones, etc.), or other types of a processor (including a reduced instruction set computer (RISC) processor or a complex instruction set computer (CISC)). Various types of computer networks 503 may be utilized including wired (e.g., Ethernet, Gigabit, Fiber, etc.) or wireless networks (such as cellular, 3G (Third-Generation Cell-Phone Technology or 3rd Generation Wireless Format (UWCC)), 5G, Low Power Embedded (LPE), etc.). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors.

In an embodiment, one or more of the processors 502 may be the same or similar to the processors 102 of FIG. 1. For example, one or more of the processors 502 may include one or more of the cores 106 and/or cache 108. Also, the operations discussed with reference to FIGS. 1-4 may be performed by one or more components of the system 500.

A chipset 506 may also communicate with the interconnection network 504. The chipset 506 may include a graphics and memory control hub (GMCH) 508. The GMCH 508 may include a memory controller 510 (which may be the same or similar to the memory controller 120 of FIG. 1 in an embodiment) that communicates with the memory 114. The memory 114 may store data, including sequences of instructions that are executed by the CPU 502, or any other device included in the computing system 500. Also, system 500 includes logic 125 and SSD 130 (which may be coupled to system 500 via bus 522 such as illustrated, via other interconnects such as 504, where logic 125 is incorporated into chipset 506, etc. in various embodiments). In one embodiment of the invention, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk, flash, PCM, 3D Cross Point Memory, Resistive Random Access Memory, and STTRAM. Additional devices may communicate via the interconnection network 504, such as multiple CPUs and/or multiple system memories.

The GMCH 508 may also include a graphics interface 514 that communicates with a graphics accelerator 516. In one embodiment of the invention, the graphics interface 514 may communicate with the graphics accelerator 516 via an accelerated graphics port (AGP). In an embodiment of the invention, a display 517 (such as a flat panel display, touch screen, etc.) may communicate with the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display 517.

A hub interface 518 may allow the GMCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503, e.g., via a wired or wireless interface). As shown, the network interface device 530 may be coupled to an antenna 531 to wirelessly (e.g., via an Institute of Electrical and Electronics Engineers (IEEE) 802.11 interface (including IEEE 802.11a/b/g/n, etc.), cellular interface, 3G, 5G, LPE, etc.) communicate with the network 503. Other devices may communicate via the bus 522. Also, various components (such as the network interface device 530) may communicate with the GMCH 508 in some embodiments of the invention. In addition, the processor 502 and the GMCH 508 may be combined to form a single chip. Furthermore, the graphics accelerator 516 may be included within the GMCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 114 of FIGS. 1 and/or 5. Also, MCH 606 and 608 may include the memory controller 120 in some embodiments. Furthermore, system 600 includes logic 125 and SSD 130 (which may be coupled to system 600 via bus 640/644 such as illustrated, via other point-to-point connections to the processor(s) 602/604 or chipset 620, where logic 125 is incorporated into chipset 620, etc. in various embodiments).

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a high-performance graphics circuit 634 via a high-performance graphics interface 636, e.g., using a PtP interface circuit 637. As discussed with reference to FIG. 5, the graphics interface 636 may be coupled to a display device (e.g., display 517) in some embodiments.

As shown in FIG. 6, one or more of the cores 106 and/or cache 108 of FIG. 1 may be located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may communicate with a bus 640 using a PtP interface circuit 641. The bus 640 may have one or more devices that communicate with it, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503, as discussed with reference to network interface device 530 for example, including via antenna 531), audio I/O device, and/or a data storage device 648. The data storage device 648 may store code 649 that may be executed by the processors 602 and/or 604.

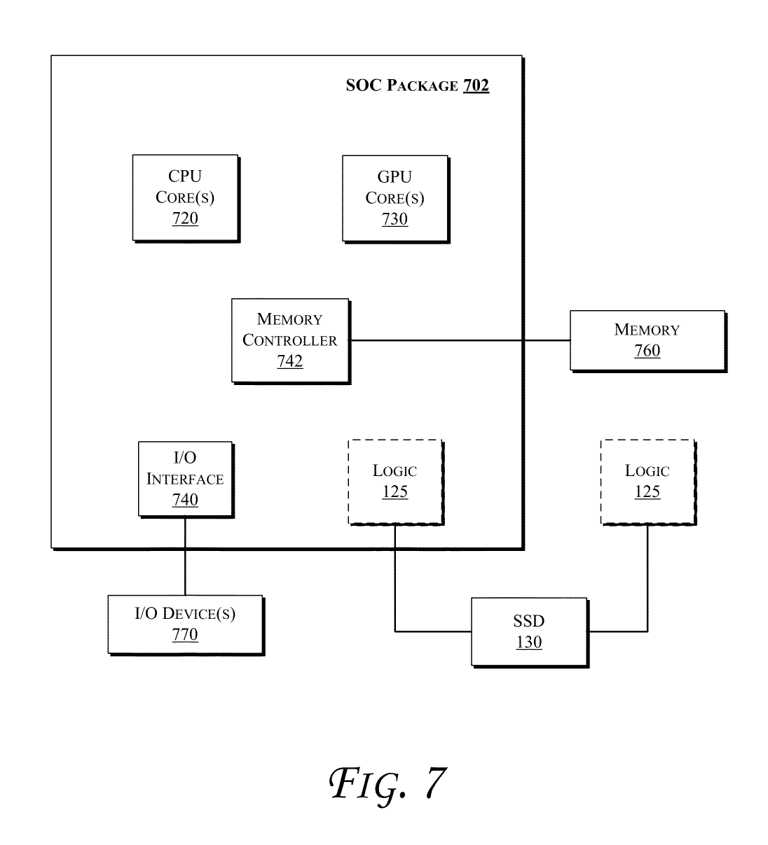

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein. In one embodiment, SOC package 702 (and its components) is provided on one or more Integrated Circuit (IC) die, e.g., which are packaged onto a single semiconductor device.

As illustrated in FIG. 7, SOC package 702 is coupled to a memory 760 (which may be similar to or the same as memory discussed herein with reference to the other figures) via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like. Furthermore, SOC package 702 may include/integrate the logic 125 in an embodiment. Alternatively, the logic 125 may be provided outside of the SOC package 702 (i.e., as a discrete logic).

The following examples pertain to further embodiments. Example 1 includes an apparatus comprising: controller logic to control access to one or more non-volatile memory devices; wherein the controller logic is to cause a change in an operational frequency of one or more of: the controller logic, a bus that couples the one or more non-volatile memory devices to the controller logic, and one or more of the one or more non-volatile memory devices, wherein the controller logic is to cause the change in the operational frequency in response to a command. Example 2 includes the apparatus of example 1, wherein the one or more non-volatile memory devices are to comprise one or more of: a solid state storage device, a phase change memory, a 3D (3-Dimensional) cross point memory, a resistive random access memory, and a spin torque transfer random access memory. Example 3 includes the apparatus of example 1, wherein the command is to comprise a smart command transport command. Example 4 includes the apparatus of example 1, wherein the command is to be issued during run-time to cause the change without a system or operating system reboot. Example 5 includes the apparatus of example 1, wherein the controller logic is to refrain from causing the change in response to a lock command. Example 6 includes the apparatus of example 1, wherein the controller logic is to refrain from causing the change in response to a value of a lock status bit. Example 7 includes the apparatus of example 1, wherein the controller logic is to cause a system reset in response to detection of an unstable operating condition associated with the one or more non-volatile memory devices. Example 8 includes the apparatus of example 1, wherein the command is to be issued by a user interface or an automated software application. Example 9 includes the apparatus of example 1, wherein the one or more non-volatile memory devices are on a same integrated circuit die. Example 10 includes the apparatus of example 1, wherein one or more of the controller logic, the one or more non-volatile memory devices, and a processor core are on a same integrated circuit die. Example 11 includes the apparatus of example 1, wherein a memory controller is to comprise the controller logic.

Example 12 includes a method comprising: controlling access to one or more non-volatile memory devices via controller logic; and causing a change in an operational frequency of one or more of: the controller logic, a bus that couples the one or more non-volatile memory devices to the controller logic, and one or more of the one or more non-volatile memory devices at the controller logic, wherein the controller logic causes the change in the operational frequency in response to a command. Example 13 includes the method of example 12, wherein the one or more non-volatile memory devices comprise one or more of: a solid state storage device, a phase change memory, a 3D (3-Dimensional) cross point memory, a resistive random access memory, and a spin torque transfer random access memory. Example 14 includes the method of example 12, wherein the command comprises a smart command transport command. Example 15 includes the method of example 12, further comprising issuing the command during run-time to cause the change without a system or operating system reboot. Example 16 includes the method of example 12, further comprising the controller logic refraining from causing the change in response to a lock command. Example 17 includes the method of example 12, further comprising the controller logic refraining from causing the change in response to a value of a lock status bit. Example 18 includes the method of example 12, further comprising the controller logic causing a system reset in response to detection of an unstable operating condition associated with the one or more non-volatile memory devices. Example 19 includes the method of example 12, further comprising issuing the command by a user interface or an automated software application.

Example 20 includes a system comprising: one or more non-volatile memory devices; and at least one processor core to access the one or more non-volatile memory devices via controller logic, wherein the controller logic is to cause a change in an operational frequency of one or more of: the controller logic, a bus that couples the one or more non-volatile memory devices to the controller logic, and one or more of the one or more non-volatile memory devices, wherein the controller logic is to cause the change in the operational frequency in response to a command. Example 21 includes the system of example 20, wherein the one or more non-volatile memory devices are to comprise one or more of: a solid state storage device, a phase change memory, a 3D (3-Dimensional) cross point memory, a resistive random access memory, and a spin torque transfer random access memory. Example 22 includes the system of example 20, wherein the command is to comprise a smart command transport command. Example 23 includes the system of example 20, wherein the command is to be issued during run-time to cause the change without a system or operating system reboot. Example 24 includes the system of example 20, wherein one or more of the controller logic, the one or more non-volatile memory devices, and the at least one processor core are on a same integrated circuit die. Example 25 includes the system of example 20, further comprising a touch screen to display data stored in the one or more non-volatile memory devices.

Example 26 includes an apparatus to adjust performance for solid state storage devices on-the-fly, the apparatus comprising: means for controlling access to one or more non-volatile memory devices coupled to controller logic; and means for causing a change in an operational frequency of one or more of: the controller logic, a bus that couples the one or more non-volatile memory devices to the controller logic, and one or more of the one or more non-volatile memory devices at the controller logic, wherein the controller logic causes the change in the operational frequency in response to a command. Example 27 includes the apparatus of example 26, comprising means for issuing the command during run-time to cause the change without a system or operating system reboot. Example 28 includes the apparatus of example 26, comprising means for refraining from causing the change in response to a lock command. Example 29 includes the apparatus of example 26, comprising means for refraining from causing the change in response to a value of a lock status bit.

Example 30 includes a computer-readable medium comprising one or more instructions that when executed on a processor configure the processor to perform one or more operations of any of examples 12 to 19.

In various embodiments of the invention, the operations discussed herein, e.g., with reference to FIGS. 1-7, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-7.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
controller logic to control access to one or more non-volatile memory devices;
wherein the controller logic is to cause a change in an operational frequency of one or more of: the controller logic, a bus that couples the one or more non-volatile memory devices to the controller logic, and one or more of the one or more non-volatile memory devices, wherein the controller logic is to cause the change in the operational frequency in response to a command.

2. The apparatus of claim 1, wherein the one or more non-volatile memory devices are to comprise one or more of: a solid state storage device, a phase change memory, a 3D (3-Dimensional) cross point memory, a resistive random access memory, and a spin torque transfer random access memory.

3. The apparatus of claim 1, wherein the command is to comprise a smart command transport command.

4. The apparatus of claim 1, wherein the command is to be issued during run-time to cause the change without a system or operating system reboot.

5. The apparatus of claim 1, wherein the controller logic is to refrain from causing the change in response to a lock command.

6. The apparatus of claim 1, wherein the controller logic is to refrain from causing the change in response to a value of a lock status bit.

7. The apparatus of claim 1, wherein the controller logic is to cause a system reset in response to detection of an unstable operating condition associated with the one or more non-volatile memory devices.

8. The apparatus of claim 1, wherein the command is to be issued by a user interface or an automated software application.

9. The apparatus of claim 1, wherein the one or more non-volatile memory devices are on a same integrated circuit die.

10. The apparatus of claim 1, wherein one or more of the controller logic, the one or more non-volatile memory devices, and a processor core are on a same integrated circuit die.

11. The apparatus of claim 1, wherein a memory controller is to comprise the controller logic.

12. A method comprising:
controlling access to one or more non-volatile memory devices via controller logic; and
causing a change in an operational frequency of one or more of: the controller logic, a bus that couples the one or more non-volatile memory devices to the controller logic, and one or more of the one or more non-volatile memory devices at the controller logic,
wherein the controller logic causes the change in the operational frequency in response to a command.

13. The method of claim 12, wherein the one or more non-volatile memory devices comprise one or more of: a solid state storage device, a phase change memory, a 3D (3-Dimensional) cross point memory, a resistive random access memory, and a spin torque transfer random access memory.

14. The method of claim 12, wherein the command comprises a smart command transport command.

15. The method of claim 12, further comprising issuing the command during run-time to cause the change without a system or operating system reboot.

16. The method of claim 12, further comprising the controller logic refraining from causing the change in response to a lock command.

17. The method of claim 12, further comprising the controller logic refraining from causing the change in response to a value of a lock status bit.

18. The method of claim 12, further comprising the controller logic causing a system reset in response to detection of an unstable operating condition associated with the one or more non-volatile memory devices.

19. The method of claim 12, further comprising issuing the command by a user interface or an automated software application.

20. A system comprising:
one or more non-volatile memory devices; and
at least one processor core to access the one or more non-volatile memory devices via controller logic;
wherein the controller logic is to cause a change in an operational frequency of one or more of: the controller logic, a bus that couples the one or more non-volatile memory devices to the controller logic, and one or more of the one or more non-volatile memory devices, wherein the controller logic is to cause the change in the operational frequency in response to a command.

21. The system of claim 20, wherein the one or more non-volatile memory devices are to comprise one or more of: a solid state storage device, a phase change memory, a 3D (3-Dimensional) cross point memory, a resistive random access memory, and a spin torque transfer random access memory.

22. The system of claim 20, wherein the command is to comprise a smart command transport command.

23. The system of claim 20, wherein the command is to be issued during run-time to cause the change without a system or operating system reboot.

24. The system of claim 20, wherein one or more of the controller logic, the one or more non-volatile memory devices, and the at least one processor core are on a same integrated circuit die.

25. The system of claim 20, further comprising a touch screen to display data stored in the one or more non-volatile memory devices.
